(19) United States
(12) Patent Application Publication
(10) Pub. No.: US 2020/0111096 A1
(43) Pub. Date: Apr. 9, 2020

(54) ARTIFICIAL INTELLIGENCE-BASED SYSTEM AND METHOD

(71) Applicant: Capital One Services, LLC, McLean, VA (US)

(72) Inventors: Zhe LIU, McLean, VA (US); Melvin JOHNSON, Washington, DC (US); Oliver DEIGHTON, Vienna, VA (US)

(21) Appl. No.: 16/151,830

(22) Filed: Oct. 4, 2018

(51) Int. Cl. G06Q 20/40; G06N 5/02; H04L 29/06; H04L 29/08

(52) U.S. Cl. CPC G06Q 20/405; G06N 5/022; H04L 67/18; H04L 67/26; H04L 65/1063

(57) ABSTRACT

Systems and methods for Artificial Intelligence (AI)-based systems and methods for conditional electronic processing that utilize enhanced AI technologies to facilitate and also automatically recommend smart transaction conditions for optimized and multi-factor electronic conditional transaction processing. An AI engine may utilize AI technologies, including facial recognition, voice recognition and/or natural language processing to parse and process the real-time input data to extract conditionally relevant meaning. The aggregated data may be continuously evaluated to determine whether the one or more smart transaction conditions is met. The determination that the one or more smart transaction conditions has been met, may trigger the AI engine to call, via an API couple to the communication interface that communicates with an account provider system, to automatically facilitate the conditional transaction.

### FIELD OF DISCLOSURE

The present disclosure relates to Artificial Intelligence (AI)-based systems and methods for conditional electronic transaction processing that utilizes a unique integration of disparate systems to facilitate the automatic execution of a transaction at an optimal instance when a condition has been satisfied. The systems and methods utilize enhanced AI technologies to facilitate and also automatically recommend smart transaction conditions for optimized and multi-factor electronic conditional transaction processing.

### BACKGROUND OF THE DISCLOSURE

Currently, electronic transaction systems require users to either make instant transactions, or schedule transactions based on a predefined date and time. Additionally, electronic transaction processing requires the manual monitoring of various data sources, including the manual selection of the data sources and manual selection of the time and frequency of the associated manual monitoring, which is time and resource intensive on the associated systems.

Furthermore, in the context of electronic financial transactions, upon initiation of a financial transaction by a customer, for example by swiping a credit card at a point of service terminal to make a purchase, a financial institution system has less than 100 milliseconds to approve the transaction. This almost instant approval time requirement does not allow for the implementation of multi-factor electronic conditional transaction processing.

These and other drawbacks exist.

### SUMMARY OF THE DISCLOSURE

Various embodiments of the present disclosure provide systems and methods for Artificial Intelligence (AI)-based systems and methods for conditional electronic processing that utilize enhanced AI technologies to facilitate and also automatically recommend smart transaction conditions for optimized and multi-factor electronic conditional transaction processing. An AI-based system is fully integrated with an account provider system and other third party systems. This unique integration facilitates the real time aggregation and evaluation of data from disparate sources including connected user devices and public data sources to automatically execute a conditional transaction.

An AI-based system for conditional electronic transaction processing may include an AI engine, an application server, data storage, and a communication interface. The AI engine may be coupled to an application programming interface (API) that enables the transmission of real time data. The AI engine may receive real time data from one or more data sources associated with the one or more smart transaction conditions. For example, the AI engine may receive real time data from connected devices, including user devices, sensors, including sensors on user devices, and/or public data systems. The received real time data may include voice data, geolocation data, and/or image data.

The AI engine may aggregate the received real time data by parsing and processing the received real time data across the one or more data sources, and may utilize AI technologies to parse and process the input data to extract conditionally relevant meaning from the input data. Specifically, AI engine may utilize AI technologies such as facial recognition, voice recognition and/or natural language processing to translate the received input data into a form that may be utilized by the AI engine to evaluate whether one or more of the smart conditions has been met. For example, AI engine may receive audio data from a connected user's device, and may utilize voice recognition and natural language processing technologies to process the input audio data to extract conditionally relevant meaning from the data.

The AI engine may continuously evaluate the aggregated data to determine whether the one or more smart transaction conditions is met. The AI engine may utilize prioritized parameters to evaluate the received real time data to generate a score that is utilized by the system to determine whether a transaction should be executed.

The determination that the one or more smart transaction conditions has been met, may trigger the AI engine to call, via an API couple to the communication interface that communicates with an account provider system, to automatically facilitate the conditional transaction, which may include a payment. A communication interface associated with an application server may transmit, via a push notification gateway, a push notification to a user application on a user device that establishes, via a network, a secure connection between the user device and the AI engine. The application server may transmit via the communication interface, a push notification to the user device, via the user application, including data indicative of the executed conditional transaction.

The AI engine may utilize machine learning and natural language processing to process and cluster the aggregated data to generate recommendations of smart transaction conditions that may be evaluated to determine whether a transaction should be executed. These system generated recommended smart transaction conditions may be stored in data storage. Additionally, an application server may transmit, via a communication interface, a push notification to a user device, via a user application, which includes the generated recommended smart transaction conditions.

The AI-based system may also facilitate multi-factor electronic conditional transaction processing. An initial smart condition may be configured such that upon occurrence of the initial smart condition, a subsequent condition must then be met for the transaction to be executed. The AI engine may continuously evaluate the aggregated data to determine whether the subsequent condition is met. For example, upon determining that the one or more smart transaction conditions has been met, the AI engine may request and receive geolocation data for a user device associated with the conditional transaction, and may utilize the received geolocation data to determine whether the user device is at a particular location specified in the smart transaction condition, and upon detecting the user device is at the particular location, may automatically execute the associated conditional transaction. The AI-based system may also include an authentication processor that may be connected to the AI engine that confirms the location of a user device associated with the conditional transaction over a wireless connection by evaluating a unique user ID—secure link token pair.

In an example embodiment, an AI-based system may allow a first user to approve a financial transaction utilizing AI technologies and conditional transaction processing at the instant a transaction is initiated. For example, upon receiving a notification that a connected second user has initiated a financial transaction, at the time the transaction is initiated. The first user may configure the associated smart condition such that the first user is required to manually approve the second user's transaction by sending a response confirming authorization via the first user's user device, upon which a request to a connected transaction system to automatically execute the associated financial transaction is transmitted.

In another embodiment, where an additional condition must be satisfied to trigger execution of a financial transaction, a first user may set up a condition that if a connected second user initiates a transaction at a particular time of day, a request will be transmitted to approve the financial transaction. A further condition may be defined, tied to the geolocation of a user device associated with the second user, such that the transaction will only be executed if the second user is actually at a defined location. As such, upon determining that it is the defined particular time of day, AI engine may evaluate geolocation data transmitted from a second user device and if there is a match, indicating that the second user is at the defined location, the AI engine may send a request to a transaction system to automatically execute the associated conditional transaction, which may include transferring money from the first user's account to the second user's account.

The unique integration of disparate systems provides a system that is able to facilitate the automatic execution of a transaction at an optimal instance when a condition has been satisfied as well as providing optimized and multi-factor electronic conditional transaction processing within the almost instant approval time requirement for financial transactions.

### BRIEF DESCRIPTION OF THE DRAWINGS

FIG. 1 depicts an example AI-based system for conditional electronic transaction processing, according to embodiments of the disclosure;

FIG. 2 depicts an example system including a backend processor, according to embodiments of the disclosure;

FIG. 3 illustrates an example system for transaction authorization, according to embodiments of the disclosure.

FIG. 4 depicts an example method for conditional electronic transaction processing utilizing AI technologies, according to embodiments of the disclosure; and

FIG. 5 depicts an example method for approving a financial transaction utilizing AI technologies and conditional transaction processing, according to embodiments of the disclosure.

### DETAILED DESCRIPTION OF THE EMBODIMENTS

The following description is intended to convey a thorough understanding of the embodiments described by providing a number of specific example embodiments and details involving AI-based systems and methods for conditional electronic transaction processing. It should be appreciated, however, that the present disclosure is not limited to these specific embodiments and details, which are examples only. It is further understood that one possessing ordinary skill in the art, in light of known systems and methods, would appreciate the use of the invention for its intended purposes and benefits in any number of alternative embodiments, depending on specific design and other needs. A financial institution and system supporting a financial institution are used as examples for the disclosure. The disclosure is not intended to be limited to financial transaction processing only. For example, the AI-based system may be utilized to facilitate may other electronic transactions, including transferring rewards points, booking travel and restaurant reservations, sending electronic communications to connected user devices, and the like.

The present disclosure is not to be limited in terms of the particular embodiments described in this application, which are intended as illustrations of various aspects. Many modifications and variations can be made without departing from its spirit and scope, as may be apparent. Functionally equivalent methods and apparatuses within the scope of the disclosure, in addition to those enumerated herein, may be apparent from the foregoing representative descriptions. Such modifications and variations are intended to fall within the scope of the appended representative claims. The present disclosure is to be limited only by the terms of the appended representative claims, along with the full scope of equivalents to which such representative claims are entitled. It is also to be understood that the terminology used herein is for the purpose of describing particular embodiments only, and is not intended to be limiting.

The foregoing description, along with its associated embodiments, has been presented for purposes of illustration only. It is not exhaustive and does not limit the invention to the precise form disclosed. Those skilled in the art may appreciate from the foregoing description that modifications and variations are possible in light of the above teachings or may be acquired from practicing the disclosed embodiments. For example, the steps described need not be performed in the same sequence discussed or with the same degree of separation. Likewise various steps may be omitted, repeated, or combined, as necessary, to achieve the same or similar objectives. Accordingly, the invention is not limited to the above-described embodiments, but instead is defined by the appended claims in light of their full scope of equivalents.

In the preceding specification, various preferred embodiments have been described with references to the accompanying drawings. It may, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

As described herein, an AI-based system facilitates smart conditional transaction processing for connected users. For example, the system may automatically identify and facilitate a consequential transaction based on the occurrence of a smart condition, which may include a financial transaction of a payment or request for payment, between connected users in response to occurrence of a user or system defined condition. An AI system may store an association between connected users, and this association may be transmitted from the AI system to a financial institution system, or other electronic transaction system, which may be stored on the financial institution's, or other transaction system's backend system. For example the association may include a link between account identifiers (e.g., account holder names, account holder usernames, account numbers, and/or the like), mobile device identifiers (e.g., mobile device numbers, mobile device carriers, mobile device application identifiers, device UUIDs, device UDIDs), transaction cards (e.g., transaction card identifiers, transaction card numbers, and/or the like) of the connected users, and other demographic identifiers (e.g., geolocation, social security number, date of birth, email address, phone number, employee identification number, student identification number, profile picture, and/or the like). Accordingly, using the information linking the connected users, upon determining that a condition has occurred, the AI system may transmit a notification that suggests or automatically triggers the execution of the associated transaction between the connected users.

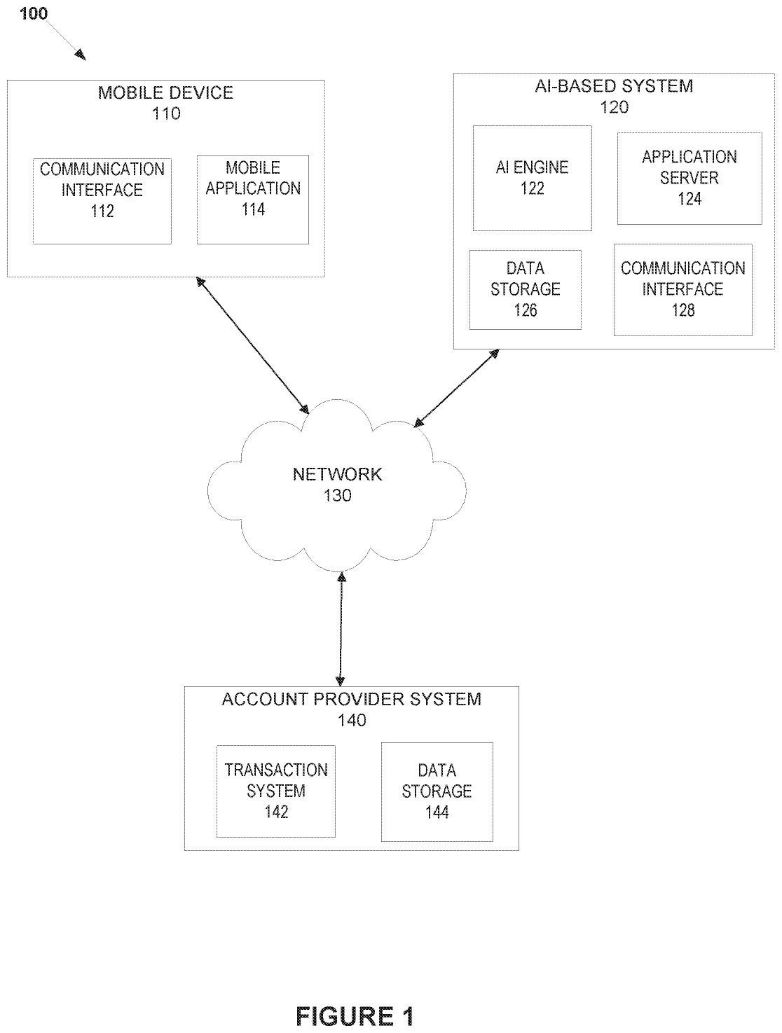

FIG. 1 depicts an example system for conditional electronic transaction processing. As shown in FIG. 1, an example system 100 may include one or more mobile devices 110, an AI-based system 120, and one or more account provider systems 140 connected over one or more networks 130.

An AI-based system 120 may access user or system defined smart transaction conditions to make or request a transaction between connected users. AI-based system 120 may have differentiated access to account provider system 140 and other third party systems, including public data source systems via private Application Programming Interfaces (APIs), and may have differentiated access to connected user devices via private Device APIs. Online registry system 120 may make calls to the APIs utilizing a token to provide a secure communication channel. The set of APIs may also provide a secure communication between mobile device 110, and AI-based system 120.

AI engine 122 may constantly identify and receive related signals associated with real time input data from one or more data sources associated with one or more smart transaction conditions, and may utilize AI technologies to parse and process the input data to extract conditionally relevant meaning from the input data. AI engine 122 may receive input data that may be collected as a subscription to a stream of data or as a periodic polling of data. The engine may iteratively collect the most recent data and compare it to the next most recent to determine if any data is new and accordingly need to be parsed and processed to extract conditionally relevant meaning. For example, a backend system may receive audio data collected from an audio input source, such as a microphone. A backend system may also periodically check and request data from an external data source, such as a weather application system.

The processed data may be aggregated across the one or more data sources. AI engine 122 may continuously evaluate the aggregated data to determine whether the one or more smart conditions is met. To minimize system resources, AI-based system 120 may store the compressed aggregated data which may include the associated conditionally relevant meaning verification and associated metadata necessary to establish proof of occurrence of the condition, rather than the raw received input data. Specifically, the system may automatically determine whether data is consequential by evaluating whether the data is pertinent to determining whether a condition has been met and/or is associated with data the does not satisfy a condition. Inconsequential data may be purged by the system to save storage space. Consequential data may also include data of previously processed transactions that may be utilized to predict the likelihood of future transactions. As such, this data that surrounds transactions (in time), that may be inferred to be consequential based on patterns may also be stored.

For example, for a condition for which AI-based system 120 facilitates the transfer of ten dollars from a parent's account to a child's account if the parent user's child does not say a bad word more than two times in a month, AI-based system upon receiving associated audio input from a child's user device, may utilize a counter to incrementally store the number of times the child has said a bad word rather than the actual received audio signal and/or specific text of the word said. The AI-based system may also store the associated metadata, including the data and time of the bad word instance. The system may also be configured to store the actual audio signal and/or specific text of the word itself that a parent user may retrieve to confirm the occurrence of the associated condition, for example, that a bad word had been said, prior to facilitating the associated conditional transaction.

Upon determining that the one or more smart transaction conditions has been met, AI engine 122 may notify the user or send a request to transaction system 142 to automatically execute the associated conditional transaction. AI engine 122 may transmit via communication interface 128 a push notification to mobile device 110 via mobile application 114 that may include data indicative the executed conditional transaction. AI engine may generate an audit log that records executed conditional transactions.

Network 130 may be one or more of a wireless network, a wired network or any combination of wireless network and wired network. Network 130 may include one or more of a fiber optics network, a passive optical network, a cable network, an Internet network, a satellite network, a wireless LAN, a Global System for Mobile Communication (“GSM”), a Personal Communication Service (“PCS”), a Personal Area Network (“PAN”), Wireless Application Protocol (WAP), Multimedia Messaging Service (MMS), Enhanced Messaging Service (EMS), Short Message Service (SMS), Time Division Multiplexing (TDM) based systems, Code Division Multiple Access (CDMA) based systems, D-AMPS, Wi-Fi, Fixed Wireless Data, IEEE 802.11b, 802.15.1, 802.11n and 802.11g, a Bluetooth network, or any other wired or wireless network for transmitting and receiving a data signal.

In addition, network 130 may include, without limitation, telephone lines, fiber optics, IEEE Ethernet 902.3, a wide area network (“WAN”), a local area network (“LAN”), a wireless personal area network (“WPAN”), a wide body area network (“WBAN”) or a global network such as the Internet. Also network 130 may support an Internet network, a wireless communication network, a cellular network, or the like, or any combination thereof. Network 130 may further include one network, or any number of the example types of networks mentioned above, operating as a stand-alone network or in cooperation with each other. Network 130 may utilize one or more protocols of one or more network elements to which they are communicatively coupled. Network 130 may translate to or from other protocols to one or more protocols of network devices. Although network 130 is depicted as a single network, it should be appreciated that according to one or more embodiments, network 130 may comprise a plurality of interconnected networks, such as, for example, the Internet, a service provider's network, a cable television network, corporate networks, and home networks.

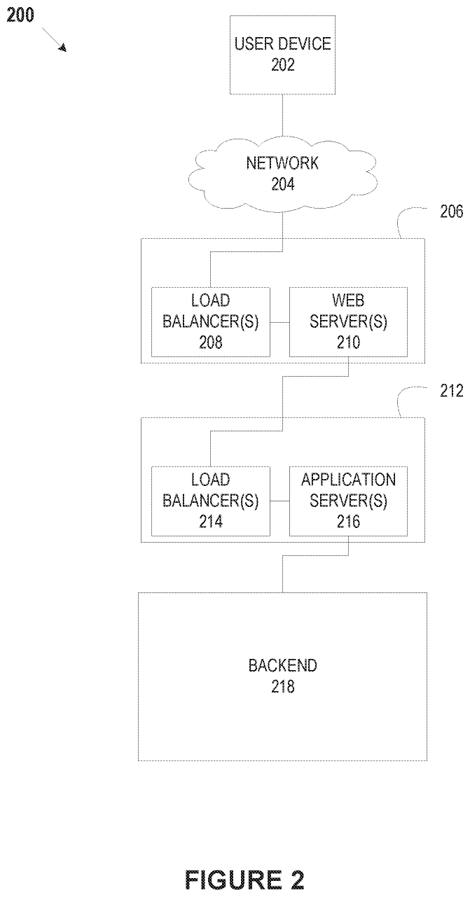

AI-based system 120, account provider system 140, and/or mobile device 110 may include a network-enabled computer system and/or device. As referred to herein, a network-enabled computer system and/or device may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The network-enabled computer systems may execute one or more software applications to, for example, receive data as input from an entity accessing the network-enabled computer system, process received data, transmit data over a network, and receive data over a network. For example, online registry system 120 may include, for example, components illustrated in FIG. 2.

AI-based system 120, account provider system 140, and/or mobile device 110, may include at least one central processing unit (CPU), which may be configured to execute computer program instructions to perform various processes and methods. AI-based system 120, account provider system 140, and/or mobile device 110 may include data storage, including for example, random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel® file, Microsoft® Access® file, a solid state storage device, which may include an all flash array, a hybrid array, or a server-side product, enterprise storage, which may include online or cloud storage, or any other storage mechanism.

AI-based system 120, account provider system 140, and mobile device 110 may further include, for example, a processor, which may be several processors, a single processor, or a single device having multiple processors. Although depicted as single elements, it should be appreciated that according to one or more embodiments, AI-based system 120, account provider system 140, and mobile device 110, and/or may comprise a plurality of AI-based systems 120, account provider systems 140, and mobile device 110. As shown in FIG. 1, AI-based system 120, account provider system 140, and mobile device 110 may include various components. As used herein, the term “component” may be understood to refer to computer executable software, firmware, hardware, and/or various combinations thereof. It is noted there where a component is a software and/or firmware component, the component is configured to affect the hardware elements of an associated system. It is further noted that the components shown and described herein are intended as examples. The components may be combined, integrated, separated, or duplicated to support various applications. Also, a function described herein as being performed at a particular component may be performed at one or more other components and by one or more other devices instead of or in addition to the function performed at the particular component. Further, the components may be implemented across multiple devices or other components local or remote to one another. Additionally, the components may be moved from one device and added to another device, or may be included in both devices.

As depicted in FIG. 1, AI-based system 120 may include AI engine 122, application server 124, data storage 126, and communication interface 128. AI-based system 120 may include data and/or components, systems, and interfaces, including application programming interfaces (APIs) to enable the generation, transmission, and processing of data including digital authentication data.

AI engine 122 may access user or system defined smart transaction conditions to make or request a transaction between connected users. The smart transaction conditions may be stored in data storage 126. For example, a user may utilize mobile application 114 to set up a condition that whenever a parent user's child says a bad word, AI-based system 120 will facilitate the transfer of one dollar from the child's account to the parent's account.

AI engine 122 may receive real time input data from one or more data sources associated with one or more smart transaction conditions, and may utilize AI technologies to parse and process the input data to extract conditionally relevant meaning from the input data. In this example, AI engine 122 may receive audio data from the child's user device, and may utilize voice recognition and natural language processing technologies to process the input audio data to extract conditionally relevant meaning from the data, which in this example would process and extract meaning from the audio data to determine whether the child had said a bad word. Accordingly, AI engine 122 may determine whether the one or more smart conditions is met. Upon determining that the one or more smart transaction conditions has been met, AI engine 122 may send a request to transaction system 142 to automatically execute the associated conditional transaction. The determination that the smart condition has been met, in this example, that the child has said a bad word, may trigger AI engine 122 to call via an API coupled to communication interface 128 that communicates with account provider system 140 to automatically facilitate the conditional transaction, transferring one dollar from the child's account to the parent's account.

As depicted in FIG. 1, mobile device 110 may be any device capable of communicating via, for example, Bluetooth technology, NFC technology, WiFi Direct technology, and/or the like and execute various functions to transmit and receive user data (e.g., smart transaction conditions, card number, account type, account balance, account limits, budget data, recent transactions, and/or the like). Mobile device 110 may include components to send and/or receive data for use in other components, such as communications interface 112. For example, user device 140 could be an iPhone, iPod, iPad, and/or Apple Watch from Apple® or other mobile device running Apple's iOS operating system, devices running Google's Android® operating system, including, for example, smartphones running the Android® operating system and other wearable mobile devices, such as Google Glass or Samsung Galaxy Gear Smartwatch, devices running Microsoft's Windows® Mobile operating system, and/or any other smartphone, smartwatch, tablet, or like device, which may include personal assistant devices incorporating systems, such as Alexa, Siri, Google Assistant, and Microsoft Cortana, including home assistant devices such as Amazon Echo, Google Home, and the like.

Mobile device 110 may include components to send and/or receive data for use in other components, such as communication interface 112. A communication interface 112 may include various hardware and software components, such as, for example, a repeater, a microwave antenna, a cellular tower, or another network access device capable of providing connectivity between network mediums. The communication interface 112 may also contain various software and/or hardware components to enable communication over a network 130. For example, communication interface 112 may be capable of sending or receiving signals via network 130. Moreover, communication interface 112 may provide connectivity to one or more wired networks and may be capable of receiving signals on one medium such as a wired network and transmitting the received signals on a second medium such as a wireless network. One or more connected users may access network 130 through one or more mobile devices 110 that also may be communicatively coupled to network 130.

The current location of mobile device 110 may be determined using many different technologies such as GPS technology, Internet-based technology, etc., which may utilize location data. By way of example, location data may include, but is not limited to GPS data, assisted GPS data, IP address data, cell ID data, received signal strength indication (RSSI) data, wireless fingerprinting data, inertial sensor data (e.g., compass or magnetometer data, accelerometer data, and/or gyroscope data), barometer data, ultrasonic data (e.g., radio-frequency identification (RFID) data, near-field communication (NFC) data), Bluetooth data, and/or terrestrial transmitter data.

Mobile device 110 may also include various software components to facilitate the conditional transaction processing, which may include account and payment operations, including an application processor (not shown in FIG. 1). For example, mobile device 110 may include an operating system such as, for example, the iOS® operating system from Apple®, the Google® Android® operating system, and the Windows Mobile® operating system from Microsoft®. Mobile device 110 may also include, without limitation, software applications such as mobile banking applications and financial institution applications to facilitate transactions, an NFC application programming interface, and software to enable touch sensitive displays. Mobile device manufacturers may provide software stacks or Application Programming Interfaces (APIs) which allow software applications to be written on top of the software stacks. For example, mobile device manufacturers may provide, without limitation, a card emulation API to enable NFC card emulation mode, a logic link control protocol (LLCP) API for peer-to-peer communication between mobile devices, a Bluetooth® API supporting BLE, and a real-time data (RTD) API and a NFC Data Exchange Format (NDEF) API for reading/writing.

The application processor may enable execution of software applications on mobile device 110, which may include mobile application 114, which may include various user interfaces, which may leverage account data, user device data, transaction data, wireless data connection, over-the-air data connection, or other means of data transmission to allow user to set up transaction conditions that may be evaluated to automatically facilitate transactions with connected users.

The data used in the application may be transmitted, for example, from external data sources. The application and user interface may leverage information from public data sources, which may include traffic, weather, financial, legal data information and the like, as well information about the account or account holder, information about the merchant and/or other parties involved in a transaction, rewards information, promotional information, advertising information, and other useful information. Software applications on mobile device 110, including, for example, mobile application 114, which may be integrated with or separate from a mobile wallet application, which may be utilized to seamlessly facilitate transactions between connected users based on the future occurrence of a condition.

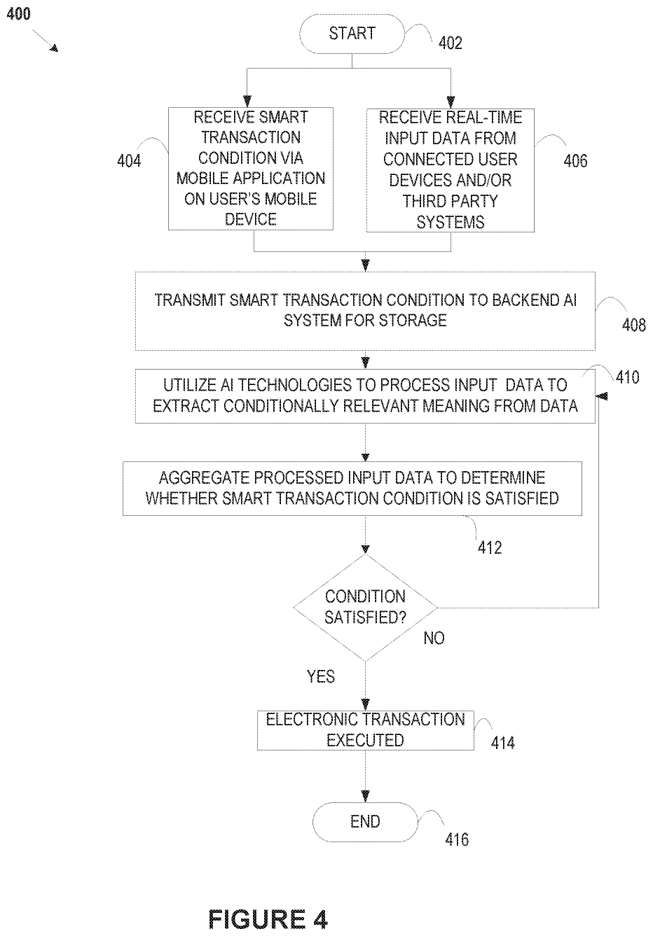

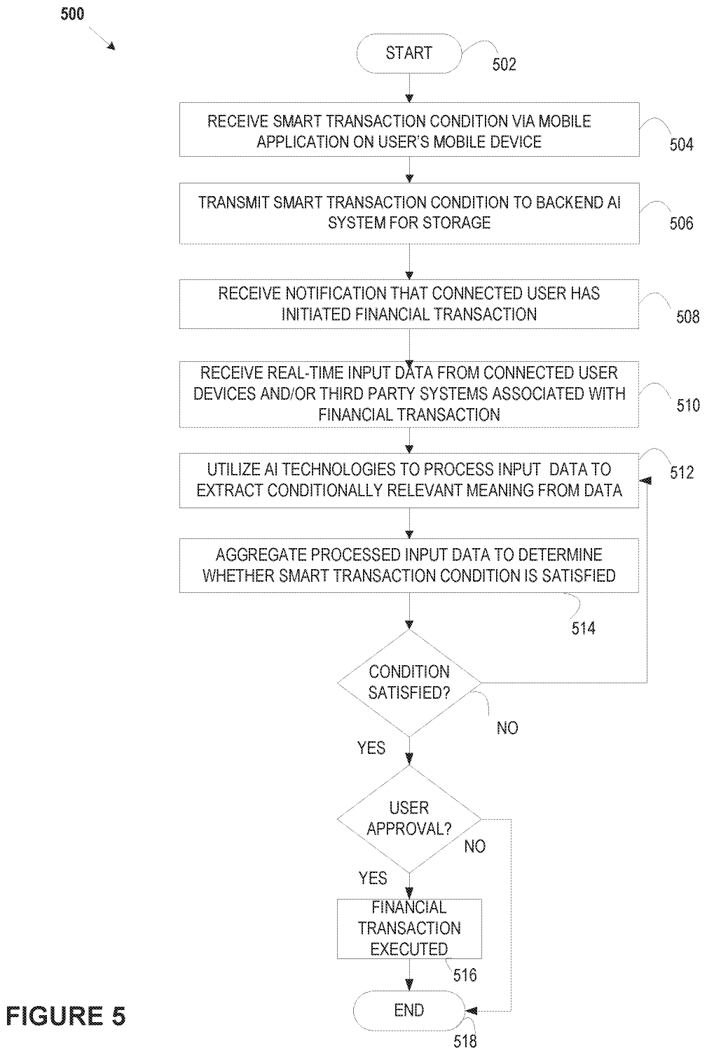

Account provider system 140 may include systems associated with, for example, a banking service company such as Capital One®, Bank of America®, Citibank®, Wells Fargo®, Sun Trust®, various community banks, and the like, as well as a number of other financial institutions such as Visa®, MasterCard®, and American Express® that issue credit and/or debit cards, for example, as transaction cards. Account provider system 140 may include and/or be connected to one or more computer systems and networks to process transactions. For example, account provider system 140 may process transactions as shown and described in FIGS. 4 and 5 below. Account provider system 140 may include systems associated with financial institutions that issue transaction cards, including dynamic transaction cards, and maintains a contract with cardholders for repayment. In various embodiments, an account provider system 140 may issue credit, debit, and/or stored value account. for example. Account provider system 140 may include, by way of example and not limitation, depository institutions (e.g., banks, credit unions, building societies, trust companies, mortgage loan companies, pre-paid gift cards or credit cards, etc.), contractual institutions (e.g., insurance companies, pension funds, mutual funds, etc.), investment institutions (e.g., investment banks, underwriters, brokerage funds, etc.), and other non-bank financial institutions (e.g., pawn shops or brokers, cashier's check issuers, insurance firms, check-cashing locations, payday lending, currency exchanges, microloan organizations, crowd-funding or crowd-sourcing entities, third-party payment processors, etc.).

Account provider system 140 may include a transaction system 142 and data storage 144. Transaction system 142 may include various hardware and software components to communicate between a merchant, acquisition system, account provider system, and/or a user device to process a transaction, such as a user purchase. Data storage 144 may store data associated with an accounts of connected users (e.g., card number, account type, account balance, account limits, budget data, recent transactions, pairing data such as time and date of pairing with a mobile device, and the like) and account holder data (e.g., account holder name, address, phone number(s), email address, demographic data, and the like).

Referring to FIG. 2, system 200 may include an AI-based system that facilitates conditional electronic transaction processing. For example, system 200 may include a user device 202, which may be similar to mobile device 110, a network 204, which may be similar to network 130, a front-end controlled domain 206, a back-end controlled domain 212, and a backend system 218. Front-end controlled domain 206 may include one or more load balancers 208 and one or more web servers 210. Back-end controlled domain 212 may include one or more load balancers 214 and one or more application servers 216.

User device 202 may be a network-enabled computer. As referred to herein, a network-enabled computer may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The one or more network-enabled computers of the example system 200 may execute one or more software applications to enable, for example, network communications.

User device 202 may include an iPhone®, iPod®, iPad®, and/or Apple Watch® from Apple® or any other mobile device running Apple's iOS® operating system, any device running Google's Android® operating system, including for example, Google's wearable device, Google Glass®, any device running Microsoft's Windows® Mobile operating system, and/or any other smartphone or like wearable mobile device.

Network 204 may be one or more of a wireless network, a wired network, or any combination of a wireless network and a wired network. For example, network 304 may include one or more of a fiber optics network, a passive optical network, a cable network, an Internet network, a satellite network, a wireless LAN, a Global System for Mobile Communication (GSM), a Personal Communication Service (PCS), a personal area network, (PAN), D-AMPS, Wi-Fi, fixed wireless data, IEEE 802.11b, 802.15.1, 802.11n, and 802.11g or any other wired or wireless network for transmitting and receiving a data signal.

In addition, network 204 may include, without limitation, telephone lines, fiber optics, IEEE Ethernet 902.3, a wide area network (WAN), a local area network (LAN), a wide body area network (“WBAN”) or a global network such as the Internet. Also, network 204 may support an Internet network, a wireless communication network, a cellular network, or the like, or any combination thereof. Network 204 may further include one network, or any number of example types of networks mentioned above, operating as a stand-alone network or in cooperation with each other. Network 304 may utilize one or more protocols of one or more network elements to which they are communicatively couples. Network 204 may translate to or from other protocols to one or more protocols of network devices. Although network 204 is depicted as a single network, it should be appreciated that according to one or more embodiments, network 204 may comprise a plurality of interconnected networks, such as, for example, the Internet, a service provider's network, a cable television network, corporate networks, and home networks.

Front-end controlled domain 206 may be implemented to provide security for backend 218. Load balancer(s) 208 may distribute workloads across multiple computing resources, such as, for example computers, a computer cluster, network links, central processing units or disk drives. In various embodiments, load balancer(s) 210 may distribute workloads across, for example, web server(s) 216 and/or backend 218 systems. Load balancing aims to optimize resource use, maximize throughput, minimize response time, and avoid overload of any one of the resources. Using multiple components with load balancing instead of a single component may increase reliability through redundancy. Load balancing is usually provided by dedicated software or hardware, such as a multilayer switch or a Domain Name System (DNS) server process.

Load balancer(s) 208 may include software that monitoring the port where external clients, such as, for example, user device 202, connect to access various services of a financial institution, for example. Load balancer(s) 208 may forward requests to one of the application servers 216 and/or backend 218 servers, which may then reply to load balancer 208. This may allow load balancer(s) 208 to reply to user device 202 without user device 202 ever knowing about the internal separation of functions. It also may prevent user devices from contacting backend servers directly, which may have security benefits by hiding the structure of the internal network and preventing attacks on backend 218 or unrelated services running on other ports, for example.

A variety of scheduling algorithms may be used by load balancer(s) 208 to determine which backend server to send a request to. Simple algorithms may include, for example, random choice or round robin. Load balancers 208 also may account for additional factors, such as a server's reported load, recent response times, up/down status (determined by a monitoring poll of some kind), number of active connections, geographic location, capabilities, or how much traffic it has recently been assigned.

Load balancers 208 may be implemented in hardware and/or software. Load balancer(s) 308 may implement numerous features, including, without limitation: asymmetric loading; Priority activation: SSL Offload and Acceleration; Distributed Denial of Service (DDoS) attack protection; HTTP/HTTPS compression; TCP offloading; TCP buffering; direct server return; health checking; HTTP/HTTPS caching; content filtering; HTTP/HTTPS security; priority queuing; rate shaping; content-aware switching; client authentication; programmatic traffic manipulation; firewall; intrusion prevention systems.

Web server(s) 210 may include hardware (e.g., one or more computers) and/or software (e.g., one or more applications) that deliver web content that can be accessed by, for example a client device (e.g., user device 202) through a network (e.g., network 204), such as the Internet. In various examples, web servers, may deliver web pages, relating to, for example, online banking applications and the like, to clients (e.g., user device 202). Web server(s) 210 may use, for example, a hypertext transfer protocol (HTTP/HTTPS or sHTTP) to communicate with user device 202. The web pages delivered to user device may include, for example, HTML documents, which may include images, style sheets and scripts in addition to text content.

A user agent, such as, for example, a web browser, web crawler, or native mobile application, may initiate communication by making a request for a specific resource using HTTP/HTTPS and web server 210 may respond with the content of that resource or an error message if unable to do so. The resource may be, for example a file on stored on backend 218. Web server(s) 210 also may enable or facilitate receiving content from user device 202 so user device 202 may be able to, for example, submit web forms, including uploading of files.

Web server(s) also may support server-side scripting using, for example, Active Server Pages (ASP), PHP, or other scripting languages. Accordingly, the behavior of web server(s) 210 can be scripted in separate files, while the actual server software remains unchanged.

Load balancers 214 may be similar to load balancers 208 as described above.

Application server(s) 216 may be similar to application server 124, as described above and may include hardware and/or software that is dedicated to the efficient execution of procedures (e.g., programs, routines, scripts) for supporting its applied applications. Application server(s) 216 may comprise one or more application server frameworks, including, for example, Java application servers (e.g., Java platform, Enterprise Edition (Java EE), the .NET framework from Microsoft®, PHP application servers, and the like). The various application server frameworks may contain a comprehensive service layer model. Also, application server(s) 216 may act as a set of components accessible to, for example, a financial institution, or other entity implementing system 200, through an API defined by the platform itself. For Web applications, these components may be performed in, for example, the same running environment as web server(s) 210, and application servers 216 may support the construction of dynamic pages. Application server(s) 216 also may implement services, such as, for example, clustering, fail-over, and load-balancing. In various embodiments, where application server(s) 216 are Java application servers, the web server(s) 216 may behaves like an extended virtual machine for running applications, transparently handling connections to databases associated with backend 218 on one side, and, connections to the Web client (e.g., user device 202) on the other.

Backend 218 may include hardware and/or software that enables the backend services of, for example, a financial institution, merchant, acquisition or other entity that maintains a distributed system similar to system 200. For example, backend 318 may include, a system of record, online banking applications, encryption applications, BLE/Bluetooth connection platforms, a rewards platform, a payments platform, a lending platform, including the various services associated with, for example, auto and home lending platforms, a statement processing platform, one or more platforms that provide mobile services, one or more platforms that provide online services, a card provisioning platform, a general ledger system, and/or a location system, which may include additional capabilities, such as transaction card data generation, transaction processing, and/or transmission of account and/or transaction data. Backend 218 may be associated with various databases, including account databases that maintain, for example, cardholder information (e.g., demographic data, credit data, cardholder profile data, and the like), transaction card databases that maintain transaction card data (e.g., transaction history, account balance, spending limit, budget categories, budget spending, budget limits, and the like), connection information (e.g., public/private key pairs, UUIDs, device identifiers, and the like) and the like. Backend 218 also may be associated with one or more servers that enable the various services provided by system 200. Backend 218 may enable an online registry system to implement various functions associated with generating an enhanced distributed online registry that determines and provides registry items that are compatible with a customer acquisition.

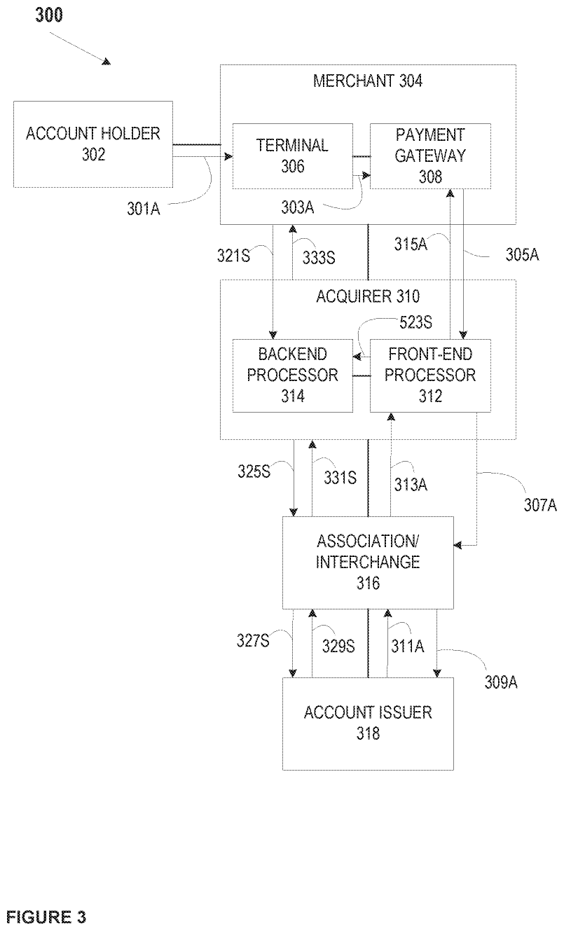

FIG. 3 illustrates an example system 300 and method for transaction authorization. As shown and described in FIG. 3, account holders, such as withdrawing parties and/or providing parties, and financial institutions may be connected with a card association network to enable secure transactions, timely payments, and successful withdrawals. System 300 may include an account holder 302, merchant 304, Acquirer 310, Association/Interchange 316, and account issuer 318.

Account holder 302 may be any withdrawing party and/or account holder, including a credit card holder, debit card holder, stored value card holder and the like. Account holder 302 may be similar to the account holder associated with mobile device 110. Account holder 302 may possess a plastic card or carry a device (e.g., a mobile device) that securely stores card credentials and is capable of transmitting the card credentials to, for example, a PoS terminal (e.g., terminal 306) and/or an input/output module. Account holder 302 may interact with a merchant and/or a providing party (e.g., merchant 304) by presenting a card or card credentials to a terminal (e.g., terminal 306).

Merchant 304 may be any merchant that accepts payment from a cardholder in exchange for a cash withdrawal, for example. Merchant 304 may be any retailer, service provider, business entity, or individual that accepts payments. Merchant 304 may include software, firmware and hardware for accepting and/or processing payments. For example, as illustrated in FIG. 3, merchant 304 may include a terminal 306 and a payment gateway 308. Terminal 306 and payment gateway 308 may comprise the physical or virtual device(s) used by merchant 304 to communicate information to front-end processor 312 of acquirer 310. Terminal 306 may be similar to a PoS system. In various embodiments, payment gateway 308 may be an e-commerce application service provider service that authorizes payments for merchants. As such, payment gateway 308 may be a virtual equivalent of a PoS terminal and interface with, for example, a billing system of merchant 304 and pass data to front-end processor 312 of acquirer 310.

Acquirer 310 may be, for example, a financial institution or bank that holds the contract for providing payment processing services to merchant 304. Merchant 304 may have a merchant account that may serve as a contract under which Acquirer 310 may extend a line of credit to a merchant who wishes to accept, for example, credit card transactions. As shown in FIG. 3, Acquirer 310 may be associated with front-end processor 312 and back-end processor 314.

In various examples, front-end processor 312 may be a platform that card terminal 306 and/or payment gateway 308 communicate with when approving a transaction and/or withdrawal. Front-end processor 312 may include hardware, firmware, and software to process transactions and/or withdrawals. Front-end processor 312 may be responsible for the authorization and capture portion of credit card transaction. Front-end processor 312 also may include additional front-end platform interconnections to support, for example, ACH and debit transactions.

Backend processor 314 may be a platform that takes captured transactions from front-end processor 312 and settles them through an Interchange system (e.g., association/interchange 316). Back-end processor 314 may generate, for example, daily ACH files for merchant settlement. Back-end processor 314 also may handle chargeback handling, retrieval request and monthly statements.

Association/interchange 316 may be the consumer payment system whose members are the financial institutions that issue payment cards and/or sign merchant to accept payment cards. Example associations/interchanges 316 may include, Visa®, MasterCard®, and American Express®. Association/interchange 316 may include one or more computer systems and networks to process transactions.

Account issuer 318 may be a financial institution that issues payment cards and maintains a contract with cardholders for repayment. In various embodiments, issuer 318 may issue credit, debit, and/or stored value cards, for example. Example issuers may include, Capital One®, Bank of America®, Citibank®, Sun Trust®, and the like.

In various embodiments, processing a payment card transaction and/or withdrawal may involve two stages: (1) authorization and (2) clearing and settlement. Authorization may refer to an electronic request that is sent through various parties to either approve or decline the transaction. Clearing and Settlement may refer to settlement of the parties' settle accounts to enable the parties to get paid.

During authorization, account holder 302 may present payment card as payment (301A) at merchant 304 PoS terminal 306, for example. Merchant 304 may enter card into a physical PoS terminal 306 or submit a credit card transaction to a payment gateway 308 on behalf of withdrawing party 302 via secure connection from a Web site, retail location, or a wireless device.

Payment gateway 308 may receive the secure transaction information (303A) and may pass the secure transaction information and/or withdrawal information (305A) via a secure connection to the merchant acquirer's 310 front-end processor 312.

Front-end processor 312 may submit the transaction and/or withdrawal request (307A) to association/interchange 316 (e.g., a network of financial entities that communicate to manage the processing, clearing and settlement of credit card transactions). Association/interchange 316 may route the transaction and/or withdrawal request (309A) to the customer's Issuer 318. Issuer 318 may approve or decline the transaction and/or withdrawal and passes the transaction and/or withdrawal results back (311A) through association/interchange 316. Association/interchange then may relay the transaction and/or withdrawal results (313A) to front-end processor 312.

Front-end processor 312 may relay the transaction results (315A) back to the payment gateway 308 and/or terminal 306. Payment gateway 308 may store the transaction and/or withdrawal results and sends them to merchant 304. Merchant 304 may receive the authorization response and complete the transaction and/or withdrawal accordingly.

During settlement, merchant 304 may deposit the transaction and/or withdrawal receipt (321S) with acquirer 310 via, for example, a settlement batch. Captured authorizations may be passed (323S) from front-end processor 312 to the back-end processor 314 for settlement. Back-end processor may generate ACH files for merchant settlement. Acquirer may submit settlement files (325S, 327S) to Issuer 318 for reimbursement via association/interchange 316. Issuer 318 may post the transaction and/or withdrawal and pay merchant 304 (329S, 331S, 333S).

FIG. 4 illustrates an example method for conditional electronic transaction processing utilizing AI technologies. The process may being at block 402. At block 404, a user may utilize various input channels to set up smart conditions to facilitate a transaction, which may include utilization of a web interface, a mobile application like mobile application 114 on mobile device 110, SMS voice recognition systems, such as Alexa, Siri, Google Assistant, and Microsoft Cortana, and the like.

The smart conditions may include conditions that define when to suggest, make or request a transaction based on the occurrence of the condition, and specifically, in one example, may include conditions to make or request a payment. The conditional transaction to be established may be executed between connected users and/or connected accounts. Joint users associated with a group may be able to establish conditional transactions to be executed between the joint users. Example smart conditions may include transferring money from a first user's account to a second user's account whenever the first user says a bad word; requesting money from a first user's account to be transferred to a second user's account when the first user is at a particular location; requesting money from a first user's account to be transferred to a second user's account when the second user is at a particular location; requesting money from a first user's account to be transferred to a second user's account when the first user is happy; approving a second user's request for a transfer of money from a first user when the second user spends less that a specified time on a particular user device, which may include playing games on an iPad; requesting money from a first user's account to be transferred to a second user's account if a particular sports team wins a game, or if a particular new law or regulation is enacted; purchasing shares of stock when the stock price goes up a certain percentage over a specified number of consecutive days, transferring money from a user's checking account to a savings account based on the occurrence of an event such as a family member's birthday, upcoming holiday, upcoming vacation, and the like.

In another example, the smart conditions may include permission controls which may be utilized to facilitate a user to opt in or opt out of the associated smart condition transaction processing and the sharing of associated user data. For example, a conditional transaction between a first and second user may include a permission control which allows the second user to accept or decline the smart conditional transaction upon occurrence of the associated condition. A conditional transaction between a first and second user may also include a confirmation control configured to require the first originator user to confirm execution of the smart transaction condition upon the occurrence of the associated condition before execution of the transaction. Additionally a conditional transaction may include a permission control that prompts a specific user to grant permission to share the necessary data to be evaluated for the associated conditional transaction processing, which may include voice, facial recognition, location, device usage data, and the like. Joint users that may be associated with a particular group may customize the level of permissions they want to give to the users in the same group. These permissions may control the sharing of user and account data, the ability to set up conditional transaction processing, and confirmation of the execution of a smart transaction condition prior to completion of the associated transaction.

At block 406, AI engine 122 may receive real-time input data securely transmitted from one or more data sources associated with one or more smart conditions, which may include connected user devices, personal device sensors, and/or third party systems, which may include public data sources and financial accounts. The system may utilize and evaluate encryption, fraud, fund availability controls, and the like, established by the third party systems to determine whether to transmit the associated input data. For example, for a smart condition involving transferring money from a first user's account to a second user's account whenever the first user says a bad word, the input data may include audio data from a first user's user device; for the smart condition involving requesting money from a first user's account to be transferred to a second user's account when the first user is at a particular location, the input data may include geolocation location data from a first user's user device; for the smart condition involving requesting money from a first user's account to be transferred to a second user's account when the second user is at a particular location, the input data may include GPS location data from a second user's user device, which may include place data such as restaurant, store, airport, and the like; for the smart condition involving requesting money from a first user's account to be transferred to a second user's account when the first user is happy, the input data may include image, video or audio data from a first user device, text data that a first user has typed or use of an emoticon; for the smart condition involving approving a second user's request for a transfer of money from a first user when the second user spends less that a specified time on a particular user device, which may include playing games on an iPad, the input data may include device/application data from a user device; for the smart condition involving requesting money from a first user's account to be transferred to a second user's account if a particular sports team wins a game, or if a particular new law or regulation is enacted, the input data may include public data from a public data source; and for the smart condition involving purchasing shares of stock when the stock price goes up a certain percentage over a specified number of consecutive days, the input data may include public data from a public data source.

AI engine 122 may collect data from individual or joint users through real-time data input sources, like those described above. Users may utilize a mobile application that is associated with application server 124, like mobile application 114 to consider the level of information they are willing to share with the system, including the data source, which may include a user device and an account provider system for which the user has an account associated with a financial institution. For example, a smart condition may be configured to include permission controls which may facilitate a user to opt in or opt out of the sharing of associated user data. A user may be prompted via a notification on mobile application 114 to grant or decline permission to share the necessary data to be evaluated for the associated conditional transaction processing, which may include voice, facial recognition, location, device usage data, and the like.

According to block 408, the smart transaction conditions may be securely stored locally in mobile application 114, may be stored within data storage 126 of backend AI-based system 120 at block 46, and/or may also be stored within an external data server. A secure connection may be made between mobile device 110, backend AI-based system 120, and/or account provider system 140 to transmit the smart transaction conditions to mobile device 110, backend AI-based system 120, and/or account provider system 140, respectively.

At block 410, AI engine 122 may utilize AI technologies to parse and process the input data to extract conditionally relevant meaning from the input data. For example, AI engine 122 may initially perform signal acquisition and filtering of a signal generated from the input data, which may be followed by further signal compression and decompression, such that the input data is in format of which AI engine 122 may extract conditionally relevant meaning from the input data. Specifically, AI engine 122 may utilize AI technologies such as facial recognition, voice recognition and/or natural language processing to translate the received input data into a form that may be utilized by AI engine 122 to evaluate whether one or more of the smart conditions has been met. For example, for the smart condition involving transferring money from a first user's account to a second user's account whenever the first user says a bad word, AI engine 122 may utilize voice recognition and natural language processing technologies to extract meaning from the voice data. Specifically the voice recognition and natural language technologies may be utilized to process the input voice data, such that AI engine 122 may utilize a pattern matching algorithm to compare the AI-processed input voice data to the defined condition, to determine when the AI-processed input data matches the defined condition, to assess whether the first user has said a bad word.

In another example, for the smart condition involving requesting money from a first user's account to be transferred to a second user's account when the first user is happy, AI engine 122 may utilize AI technologies to parse and process input data from multiple inputs to extract conditionally relevant meaning from the multiple input sources and aggregate them to verify whether a condition has been met. For example, facial recognition technologies may be utilized to process image data of an image of a user, which may be taken from a camera on a user's mobile device to detect a happy facial expression. Additionally, voice recognition and natural language processing technologies may also be utilized to process any received audio data. Geolocation data may also be processed to detect whether a user is happy based on a defined behavior which may include going to a particular location or event. Accordingly, AI engine 122 may utilize a pattern matching algorithm to aggregate compare the AI-processed input image, voice data, and geolocation data respectively to the defined condition, to determine when the AI-processed input data matches the defined condition, to assess whether the first user is happy.

At block 412 The processed data may be aggregated across the one or more data sources. For example, a condition may be associated with a particular score. AI engine 122 may utilize a data aggregator to calculate different data points based on the processed input data, and based on the aggregated data points, may utilize an algorithm to generate a score.

The algorithm may utilize specific calculations that utilize parameters to prioritize the input data in generating a score. AI engine 122 may compare the system generated score to the score associated with the condition to determine if there is a match to assess whether the condition has been satisfied.

The condition may also include a skill that may be made available to a user. AI engine 122 may learn new skills by utilizing historical training of data, which may include geolocation, proximity to people, words spoken, images taken, weather, time, demographic data, and the like. The historical training of data may include aggregating such and associating the data with conditional transactions to determine patterns that predict future conditional transaction processing.

AI engine 122 may continuously evaluate the aggregated data to determine whether the one or more smart conditions is met.

At block 412, upon determining that the one or more smart transactions has been met, AI engine 122 may send a request to transaction system 142 to automatically execute the associated conditional transaction. AI engine 122 may transmit via communication interface 128 a push notification to mobile device 110 via mobile application 114 that may include data indicative the executed conditional transaction.

In one embodiment, AI-based system may utilize multi-factor conditional transaction processing. Specifically, an initial smart condition may be configured such that upon occurrence of the initial smart condition, a subsequent condition must then be met for the transaction to be executed. AI engine 122 may continuously evaluate the aggregated data to determine whether the subsequent condition is met. For example, if a parent user sets up a condition that at lunch time, a request will be transmitted to transfer lunch money from a parent's account to a child's account. A further condition may be defined, tied to the geolocation of a user device associated with the child, such that the transaction will only be executed if the child is actually at school. As such, upon determining that it is lunch time, AI engine will evaluate geolocation data transmitted from a user device of a child and if there is a match, indicating that the child is at school, AI engine 122 may send a request to transaction system 142 to automatically execute the associated conditional transaction of transferring lunch money from the parent's account to the child's account. In another example, for a condition for which AI-based system 120 facilitates the transfer of ten dollars from a parent's account to a child's account if the parent user's child does not say a bad word more than two times in a month based on received audio input from a child's user device. A further condition may be defined, tied to voice recognition associated with the child's voice input, such that the transaction will only be executed if it is actually the identified child rather than a sibling or a classmate that says the bad word. As such, upon determining that a bad word has been said, AI engine will utilize voice recognition technologies to detect if there is a match, indicating that the identified child did in fact say the bad word.

The smart conditions may also include permission control which may be utilized to facilitate a user to opt in or opt out of a smart condition transaction processing. For example, a conditional transaction between a first and second user may include a permission control which allows the second user to accept or decline the smart conditional transaction upon occurrence of the associated transaction. Upon determining that a condition has been satisfied, AI engine may transmit a notification to a user device associated with the second transaction recipient user, which may prompt the second user to accept or decline the execution of the associated transaction.

AI engine 122 may also utilize machine learning and natural language processing to process and cluster the aggregated data, and may utilize a recommendation algorithm to generate recommendations of smart transaction conditions based on user and/or other connected user's previously defined conditions. Specifically, AI engine 122 may utilize a constant feedback loop to learn about system conditions that may trigger a transaction to build associations and correlations of the system conditions and aggregated data to automatically suggest a smart condition that may trigger an associated transaction. For example, the system may determine that parent users transfer money to their children during lunch time. Based on the system building an association between the transfer of money from parent users to children users and lunch time, and also potentially determination of a child's location at school, the system may automatically suggest a smart trigger to other parent users that triggers parent users transfer money to their children during lunch time.

In another example, the system may further learn moments and triggers that may result in a transaction between users. For example, the system determine that two users are at a particular restaurant. The system may, based on evaluating aggregated data, automatically suggest a smart trigger condition that if two people are in the same location, and the location is a restaurant, the system should send a notification asking the users if they would like to split the bill.

The process may end at block 416.

FIG. 5 depicts an example method that allows a user to approve a financial transaction utilizing AI technologies and conditional transaction processing at the instant a transaction is initiated, according to embodiments of the disclosure. The process may being at block 502. At block 504, a user may utilize various input channels to set up smart conditions to facilitate a transaction, which may include utilization of a web interface, a mobile application like mobile application 114 on mobile device 110, SMS voice recognition systems, such as Alexa, Siri, Google Assistant, and Microsoft Cortana, and the like. The smart conditions may include conditions that define when to make or request a transaction based on the occurrence of the condition, and specifically, in one example, may include conditions to make or request a payment. For example, a parent user may define a condition that requires when a connected child user initiates a financial transaction, the parent user must manually approve the financial transaction, or an additional condition must be satisfied which triggers execution of the financial transaction.

According to block 506, the smart transaction conditions may be securely stored locally in mobile application 114, may be stored within data storage 126 of backend AI-based system 120 at block 46, and/or may also be stored within an external data server. A secure connection may be made between mobile device 110, backend AI-based system 120, and/or account provider system 140 to transmit the smart transaction conditions to mobile device 110, backend AI-based system 120, and/or account provider system 140, respectively.

At block 508, AI engine 122 may receive a notification that a connected user has initiated a financial transaction. For example a child user may swipe a card, to purchase lunch at school. Upon swiping the card, a parent user may receive a notification via AI system 120, pushed to a user device of the parent at the time the transaction is initiated. The parent user may configure the associated smart condition such that the parent user is required to manually approve the child's transaction by sending a response confirming authorization via the parent's user device, upon which a request to a connected transaction system to automatically execute the associated financial transaction is transmitted. If the parent user does not approve the child's transaction, the process may end at 518.

In another embodiment, where an additional condition must be satisfied to trigger execution of the financial transaction, at block 510, AI engine 122 may receive real-time input data securely transmitted from one or more data sources associated with one or more smart conditions, which may include connected user devices, personal device sensors, and/or third party systems, which may include public data sources and financial accounts. For example, if a parent user sets up a condition that if a child initiates a transaction at lunch time, a request will be transmitted to approve the financial transaction. A further condition may be defined, tied to the geolocation of a user device associated with the child, such that the transaction will only be executed if the child is actually at school. As such, upon determining that it is lunch time, AI engine will evaluate geolocation data transmitted from a user device of a child and if there is a match, indicating that the child is at school, AI engine 122 may send a request to transaction system 142 to automatically execute the associated conditional transaction of transferring lunch money from the parent's account to the child's account.

At block 510, AI engine 122 may utilize AI technologies to parse and process the input data to extract conditionally relevant meaning from the input data. For example, AI engine 122 may initially perform signal acquisition and filtering of a signal generated from the input data, which may be followed by further signal compression and decompression, such that the input data is in format from which AI engine 122 may extract conditionally relevant meaning from the input data. Specifically, AI engine 122 may utilize AI technologies such as facial recognition, voice recognition and/or natural language processing to translate the received input data into a form that may be utilized by AI engine 122 to evaluate whether one or more of the smart conditions has been met.

At block 514, the processed data may be aggregated across the one or more data sources. For example, a condition may be associated with a particular score. AI engine 122 may utilize a data aggregator to calculate different data points based on the processed input data, and based on the aggregated data points, may utilize an algorithm to generate a score. The algorithm may utilize specific calculations that utilize parameters prioritize the input data in generating a score. AI engine 122 may compare the system generated score to the score associated with the condition if there is a match to assess whether the condition has been satisfied.

AI engine 122 may continuously evaluate the aggregated data to determine whether the one or more smart conditions is met.

At block 516, upon determining that the one or more smart transactions has been met, AI engine 122 may send a request to transaction system 142 to automatically execute the associated conditional transaction. AI engine 122 may transmit via communication interface 128 a push notification to mobile device 110 via mobile application 114 that may include data indicative the executed conditional transaction.

The process may end at block 518.

The present disclosure is not to be limited in terms of the particular embodiments described in this application, which are intended as illustrations of various aspects. Many modifications and variations can be made without departing from its spirit and scope, as may be apparent. Functionally equivalent methods and apparatuses within the scope of the disclosure, in addition to those enumerated herein, may be apparent from the foregoing representative descriptions. Such modifications and variations are intended to fall within the scope of the appended representative claims. The present disclosure is to be limited only by the terms of the appended representative claims, along with the full scope of equivalents to which such representative claims are entitled. It is also to be understood that the terminology used herein is for the purpose of describing particular embodiments only, and is not intended to be limiting.

The foregoing description, along with its associated embodiments, has been presented for purposes of illustration only. It is not exhaustive and does not limit the invention to the precise form disclosed. Those skilled in the art may appreciate from the foregoing description that modifications and variations are possible in light of the above teachings or may be acquired from practicing the disclosed embodiments. For example, the steps described need not be performed in the same sequence discussed or with the same degree of separation. Likewise various steps may be omitted, repeated, or combined, as necessary, to achieve the same or similar objectives. Accordingly, the invention is not limited to the above-described embodiments, but instead is defined by the appended claims in light of their full scope of equivalents.

In the preceding specification, various preferred embodiments have been described with references to the accompanying drawings. It may, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

1. An Artificial Intelligence (AI)-based system for conditional electronic transaction processing, comprising:
a data storage containing user identification information and one or more smart transaction conditions;
an AI engine coupled to an application programming interface (API) that enables the transmission of real time data, wherein the AI engine:
receives real time data from one or more data sources associated with the one or more smart transaction conditions;
aggregates the received real time data by parsing and processing the received real time data across the one or more data sources to extract conditionally relevant metadata;
continuously evaluates the aggregated data to determine whether the one or more smart transaction conditions is met;
generates recommendations of smart conditions that may be evaluated to determine whether a transaction should be executed based on machine learning and natural language processing of the aggregated data utilizing a constant feedback loop; and
upon determining that the one or more smart transaction conditions has been met, sends a request to a connected transaction system to automatically execute the associated conditional transaction;
an application server storing a user application; and
a communication interface associated with the application server, that transmits, via a push notification gateway, a push notification to a user application on a user device that establishes, via a network, a secure connection between the user device and the AI engine.

2. The system of claim 1, wherein the AI engine receives real time data from connected devices, sensors, and/or public data systems.

3. The system of claim 2, wherein the real time data includes voice data, geolocation data, and/or image data.

4. The system of claim 3, wherein the AI engine utilizes voice recognition and natural language processing to translate voice data into a form that may be utilized by the engine to evaluate whether one or more of the smart transaction conditions has been met.

5. (canceled)

6. The system of claim 5, wherein the AI engine stores the generated recommended smart transaction conditions in the data storage.

7. The system of claim 5, wherein the application server transmits, via the communication interface, a push notification to the user device, via the user application, wherein the push notification includes the generated recommended smart transaction conditions.

8. The system of claim 1 wherein the AI engine utilizes prioritized parameters to evaluate the received real time data to generate a score that is utilized by the system to determine whether a transaction should be executed.

9. The system of claim 1, wherein upon determining that the one or more smart transaction conditions has been met, the AI engine requests and receives geolocation data for a user device associated with the conditional transaction, utilizes the received geolocation data to determine whether the user device is at a particular location specified in the smart transaction condition, and upon detecting the user device is at the particular location, automatically executes the associated conditional transaction.

10. The system of claim 1, further comprising an authentication processor connected to the AI engine that confirms the location of a user device associated with the conditional transaction over a wireless connection by evaluating a unique user ID—secure link token pair.

11. The system of claim 1, wherein the application server transmits, via the communication interface, a push notification to the user device, via the user application, wherein the push notification includes data indicative of the executed conditional transaction.

12. An AI-based method, comprising:
receiving, in real time, data from one or more data sources associated with the one or more smart transaction conditions;
aggregating the received real time data across the one or more data sources to extract conditionally relevant metadata;
continuously evaluating the aggregated data to determine whether the one or more smart transaction conditions is met;
upon determining that the one or more smart transaction conditions has been met, sending a request to a connected transaction system to automatically execute the associated conditional transaction;
generating recommendations of smart conditions that may be evaluated to determine whether a transaction should be executed based on machine learning and natural language processing of the aggregated data utilizing a constant feedback loop; and
transmitting, via a communication interface, a push notification to a user device associated with the conditional transaction, wherein the push notification includes data indicative of the executed conditional transaction.

13. The method of claim 12, further comprising utilizing voice recognition and natural language processing to translate voice data into a form that may be utilized to evaluate whether one or more of the smart transaction conditions has been met.

14. (canceled)

15. The method of claim 14, further comprising storing the generated recommended smart transaction conditions in a data storage.

16. The method of method 14, further comprising transmitting, via the communication interface, a push notification to the user device, via a user application, wherein the push notification includes the generated recommended smart transaction conditions.

17. The method of claim 12, further comprising utilizing prioritized parameters to evaluate the received real time data to generate a score that is utilized by the system to determine whether a transaction should be executed.

18. The method of claim 12, further comprising,
upon determining that the one or more smart transaction conditions has been met, requesting and receiving geolocation data for a user device associated with the conditional transaction;
utilizing the received geolocation data to determine whether the user device is at a particular location specified in the smart transaction condition; and
upon detecting the at the particular location, automatically executing the associated conditional transaction.

19. The method of claim 12, further comprising confirming the location of a user device associated with the conditional transaction over a wireless connection by evaluating a unique user ID—secure link token pair.

20. An AI-based system, comprising:
a data storage containing user identification information and one or more smart transaction conditions;
an AI engine coupled to an application programming interface (API) that enables the transmission of real time data, wherein the AI engine:
receives a notification that a connected user has initiated a financial transaction;
receives real time data from one or more data sources associated with the financial transaction;
aggregates the received real time data across the one or more data sources to extract conditionally relevant metadata;
continuously evaluates the aggregated data to determine whether the one or more smart transaction conditions is met; and
upon determining that the one or more smart transaction conditions has been met, sends a request to a connected transaction system to automatically execute the associated financial transaction.

21. The system of claim 1, wherein the AI engine evaluates system conditions utilizing the constant feedback loop to build associations and correlations of the system conditions and aggregated data to automatically generate a smart condition.

22. The method of claim 12, further comprising evaluates system conditions utilizing the constant feedback loop to build associations and correlations of the system conditions and aggregated data to automatically generate a smart condition.
